(19) United States
(12) Patent Application Publication
(10) Pub. No.: US 2021/0086983 A1
(43) Pub. Date: Mar. 25, 2021

(54) CAP FOR A PRESSURIZED CONTAINER WITH A DISPENSING UNIT

(71) Applicant: Vincent Stefan David GIELEN, Gastel (NL)

(72) Inventor: Vincent Stefan David GIELEN, Gastel (NL)

(21) Appl. No.: 16/492,499

(22) PCT Filed: Feb. 5, 2018
(86) PCT No.: PCT/NL2018/050078

§ 371 Date: Sep. 9, 2019

(30) Foreign Application Priority Data
Apr. 19, 2017 (NL) 2018736

(51) Int. Cl. B65D 83/22; B65D 83/14

(52) U.S. Cl. CPC B65D 83/22; B65D 83/753

(57) ABSTRACT

The invention relates to a cap for a pressurized container with a dispensing unit, wherein the cap comprises a stationary body configured to be attached to the container such that the stationary body encloses the dispensing unit of the container, the cap further comprises an actuation portion for activation of the dispensing unit of the pressurized container. The invention further relates to a container comprising a dispensing unit and a cap.

The invention relates to a cap for a pressurized container with a dispensing unit, wherein the cap comprises a stationary body configured to be attached to the container such that the stationary body encloses the dispensing unit of the container, the cap further comprises an actuation portion for activation of the dispensing unit of the pressurized container.

The invention further relates to a container comprising a dispensing unit and a cap.

A cap for a pressurized container with a dispensing unit is known from EP 2 228 319 A1. This document discloses an aerosol cap comprising a base portion and an aerosol actuation portion for interfacing with an aerosol can, in particular the fluid exit tubing from the aerosol can, wherein the aerosol actuation portion is rotationally held in the aerosol cap. The cap further comprises a slidable or rotatable locking mechanism having both a locked orientation and an unlocked orientation. The locking mechanism stops rotation of the aerosol actuation portion in the locked orientation and allows rotation of the actuation portion in the unlocked orientation.

In order to actuate the can, it is necessary to move the locking mechanism to its unlocked orientation with a first finger and to actuate the actuation portion with a different finger or alternatively repositioning the finger used for unlocking. Further, the actuation portion is located close to the spray nozzle such that it is not unlikely that after actuation of the can, a finger of a user on the actuation portion could be covered with the product dispensed from the can. Further, actuation of the actuation portion also moves the fluid channel and/or the spray nozzle which may influence the predictability of the spray direction of the product dispensed from the spray nozzle for a user.

It is an object of the present invention to provide an improved cap for a pressurized container having a dispensing unit. In particular, it is an object of the present invention to provide a cap having a relatively simple design and a cap which has an increased ease of use, i.e. is user-friendly.

This object is achieved with the cap disclosed in claim 1.

The cap to be used on a pressurized container with a dispensing unit comprises a stationary body configured to be attached to the container such that the stationary body encloses the dispensing unit of the container. The cap further comprises an actuation portion for activation of the dispensing unit of the pressurized container. The actuation portion is slidably connected to the stationary body, wherein the actuation portion can be slid by a user between a first inactive position in which the actuation portion forms a part of the top of the cap and a second active position in which the actuation portion is partly located outside the cap and vice versa. In the first inactive position the actuation portion is blocked by means of the stationary body to pivot around a pivot axis for activation of the dispensing unit and in the second active position the dispensing unit can be activated by a user by applying a force on the part of the actuation portion located outside the cap such that the actuation portion pivots around the pivot axis.

The actuation portion of the cap has a double function, in that the actuation portion is a locking mechanism and an actuation mechanism to actuate the dispensing unit of the pressurized container. Hence, in order to use and actuate the container, the actuation portion is slid to the second active position such that the actuation portion is unlocked and ready for use. Sliding of the actuation portion from the inactive first position to the active second position can be done with a single finger of the user. Then, it is possible to actuate the dispensing unit of the container with the same finger without requiring a repositioning of that finger. Hence, the cap is easy to use and user-friendly. Further, the number of components of the cap can be reduced by the double function of the actuation portion, which provides a less complex cap and also a cap that is relatively inexpensive to produce. As the part of the actuation portion to actuate the pressurized container is located outside the cap and relatively far from the dispensing unit of the container, the risk during normal use that fluid or product to be dispensed with the dispensing unit gets on a hand of a user activating that part of the actuation portion can be reduced.

In the second active position, the part of the actuation portion located outside the cap can also be operated easily by a finger of the user.

The pressurized container can also be denoted as spray can or aerosol can. The dispensing unit may comprise a press-down valve or an aerosol valve which are known in the prior art. The dispensing unit may also comprise a fluid exit tubing known from EP 2 228 319 A1 without any other exterior elements arranged on the fluid exit tubing. The dispensing unit is normally attached centrally in a mounting cup of the container, i.e. a dome shape top end of the container.

In addition, in the first inactive position of the actuation portion, the cap covers the top of the container including the dispensing unit, preferably in such a way that the cap prevents that a finger of a user is able to enter the interior of the cap, preventing access to activate the dispensing unit of the container.

In the first inactive position the actuation portion may provide a cap without a spraying opening for the dispensing unit and sliding the actuation portion to the second active position of the actuation portion provides a cap with a spraying opening for the dispensing unit. In this way, it is in the first inactive position obvious for a user that the pressurized container cannot be used and should be unlocked before use.

The cap may comprise a lever pivotably connected to the stationary body, wherein in the first inactive position the lever is located between the dispensing unit and the slidable actuation portion. The pivotable lever can be used to transfer the activation force of a user exerted on the part of the actuation portion located outside the cap to the dispensing unit for activation of the dispensing unit.

The spraying opening in the cap is provided by sliding the actuation portion from the first inactive position to the second active position of the actuation portion, wherein the spraying opening in the cap is closed by sliding the actuation portion back from the second active position to the first inactive position of the actuation portion. The spraying opening is formed/defined by the lever and the actuation portion, e.g. at least partly formed by an edge of the lever and an edge of the actuation portion. In one aspect, a first end of the lever is connected to the stationary body and at least an edge portion of the edge of the lever forming the spraying opening is part of a second end of the lever opposite, seen in a longitudinal direction of the lever, to the first end of the lever connected to the stationary body. Further, at least an edge portion of the edge of the actuation portion is in the first inactive position located closer to the first end of the lever connected to the stationary body than to the second end of the lever, wherein in the second active position of the actuation portion this edge portion of the edge of the actuation portion is located closer to the second end of the lever than to the first end of the lever.

In the second active position of the actuation portion, the lever is connected to the actuation portion such that actuation by a user of the actuation portion pivots the lever and the actuation portion around the pivot axis with respect to the stationary body thereby activating the dispensing unit of the pressurized container.

By means of the lever, it is possible that the part of the actuation portion located outside the cap is orientated in the same direction as the spraying direction of the nozzle, because the centrally arranged dispensing unit to be pushed down by means of the lever for dispensing fluid is located between the pivot axis and the part of the actuation portion located outside the cap. In other words, in the second active position the part of the actuation portion located outside the cap is located under the spraying opening, such that the spraying opening is located between the virtual center line of the cap/container and the part of the actuation portion located outside the cap. This orientation of the part of the actuation portion located outside the cap allows the user to release the contents of an aerosol can, whilst providing a good grip of the can around the circumference of the can with the rest of the hand for holding the can, with minimal risk of finger fatigue or fingertip numbness for activating the dispensing unit during use of the can. Due to the relatively low positioning of the actuation portion in the second active position with respect to the nozzle of the dispensing unit, a better view is provided for the process to be carried out with the container, for example a painting process.

A first end of the lever provides the pivotable connection with the stationary body, wherein in the first inactive position of the actuation portion a first end of the actuation portion is located closer to the first end of the lever than to an opposite second end of the lever, wherein in the second active position of the actuation portion the first end of the actuation portion is located closer to the second end of the lever than to the first end of the lever. A second end of the actuation portion opposite, seen in a longitudinal direction of the actuation portion, to the first end of the actuation portion is in the second active position located outside the cap. In the first inactive position, the second end of the actuation portion is located closer to the first end of the lever than in the second active position. In the second active position, the spraying opening is located between the second end of the actuation portion and the first end of the lever providing the pivotable connection with the stationary body.

This configuration is able to provide maximum leverage requiring minimal activation force of a user to activate the dispensing unit.

In one aspect, the actuation portion is slidable over the lever, wherein ribs and at least one recess provided on the actuation portion and the lever define the first inactive position and the second active position of the actuation portion. The ribs can be provided on the lever, such that when a user reaches the first or the second position of the actuation portion, the user feels a small resistance as a result of the rib(s) snapping into the recess(es) of the actuation portion. The ribs and the recess(es) also hold the actuation portion in a desired position. It is also possible that the lever comprises end stops that ensure that the actuation portion cannot travel further than the first inactive position seen from the second active position or further than the second active position seen from the first inactive position

The stationary body may comprise a top portion defining the top of the cap, wherein the top portion has two stepped edges and between the stepped edges the actuation portion is arranged at least in the first inactive position in such a manner that the actuation portion is able to slide over the stepped edges.

In this way, a relatively simple and cost-friendly sliding mechanism can be provided for sliding the actuation portion between the first and the second position.

In one aspect, the stepped edges are configured to block a pivoting movement of the actuation portion around a pivot axis for activation. The stepped edges have a double function in that they provide a sliding mechanism for the actuation portion and a safety feature in that the stepped edges prevent that the actuation portion can be pushed towards the interior of the cap. The stepped edges are provided over a part of the sliding path of the actuation portion for sliding between the first and second position, i.e. in the region of the second position the top portion has edges without a stepped profile such that the actuation portion is no longer blocked and can be pushed by a user towards the interior of the cap which results in a pivoting movement around the pivot axis.

For an optimal force transfer of the pivoting movement of the lever to the dispensing unit, a surface of the lever facing the interior of the cap may comprise a protruding element abutting the dispensing unit.

It is further an object of the present invention to provide an improved pressurized container having a dispensing unit. In particular, it is an object of the present invention to provide a pressurized container having a simple design and having an increased ease of operation, i.e. a user-friendly pressurized container.

This object is achieved with the claims claiming a container. Such a container comprises a cap as described in this document. The cap can be manually releasably attached to the container or the cap is manually unreleasably attached to the container. Manually unreleasably attached means that a user cannot remove the cap from the container by hand, i.e. without using tools which will most likely cause damage to the container and/or the cap. Once the manually unreleasable attached cap is removed from the container it is not possible, without additional means, to attach the cap back on the container.

The invention will now be explained in more detail with reference to the drawings and by means of a description of an exemplary embodiment of a cap and a container with a dispensing unit, wherein:

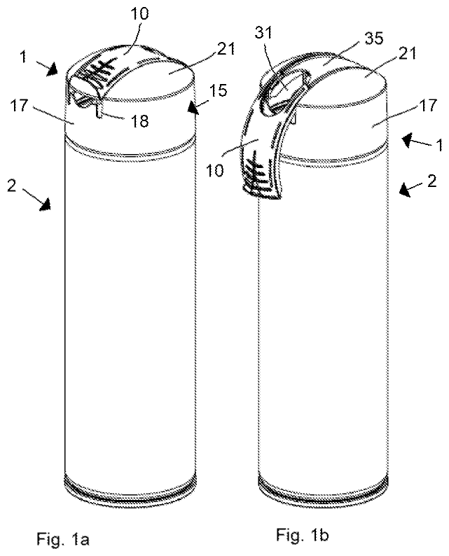

FIGS. 1a,b show perspective views of a pressurized container with a cap in a first inactive position and a second active position;

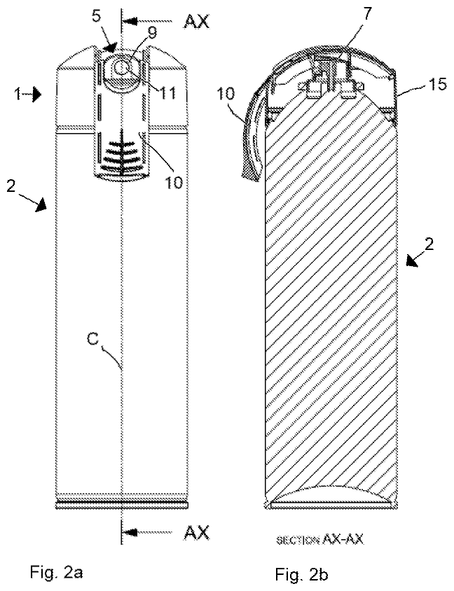

FIGS. 2a,b show a front view and a cross section of a pressurized container with a cap in an second active position;

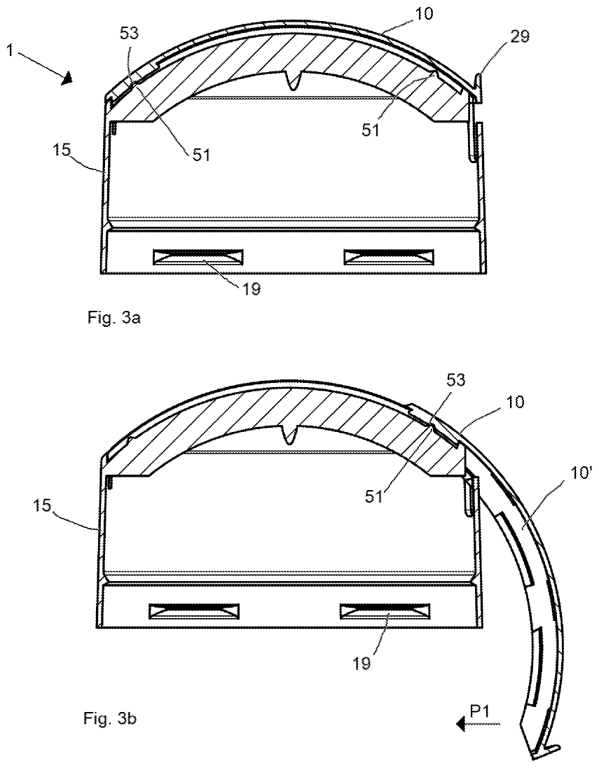

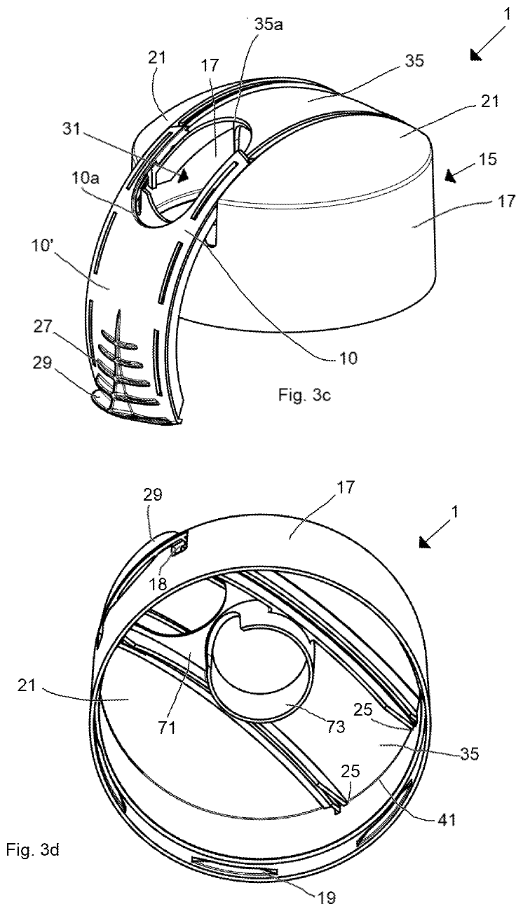

FIGS. 3a-d show cross-sections and perspective views of the cap in a first inactive position and an second active position;

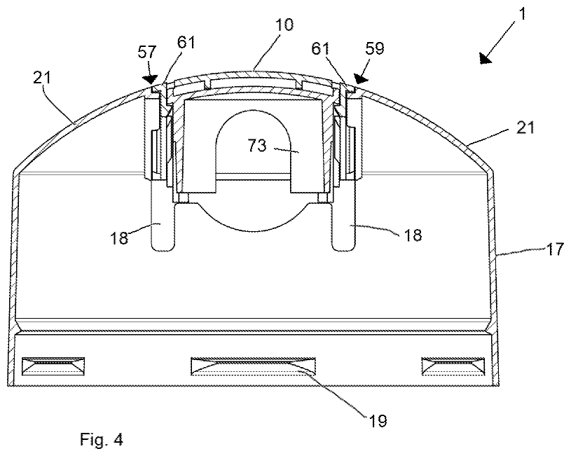

FIG. 4 shows a cross-section of the cap in the first inactive position.

In the following description identical or corresponding parts have identical or corresponding reference numerals;

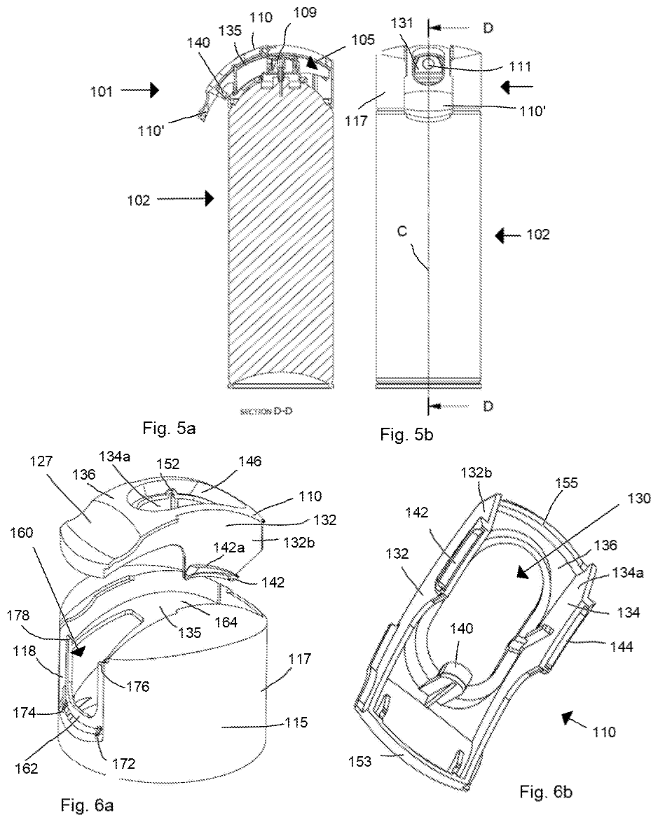

FIGS. 5a,b show perspective views of a pressurized container with another embodiment of a cap which is shown in a second active position;

FIGS. 6a,b show perspective views of components of the cap shown in FIG. 5a,b;

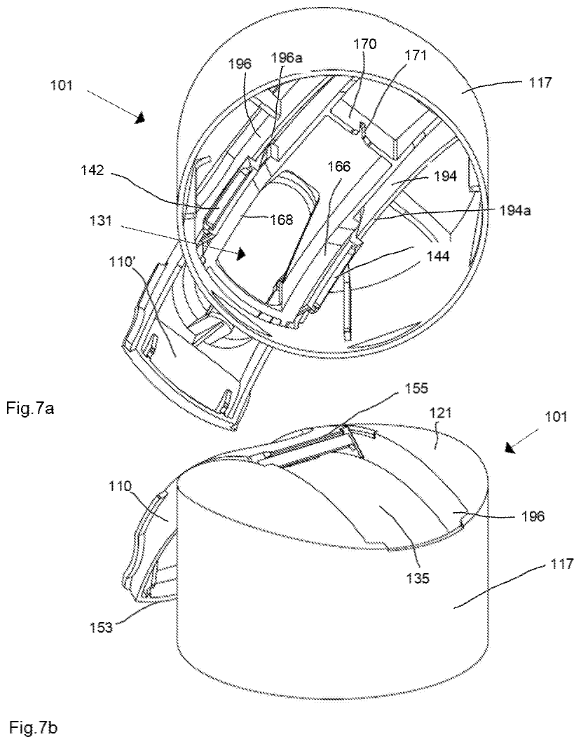

FIGS. 7a,b show perspective views of the cap shown in FIG. 5a,b;

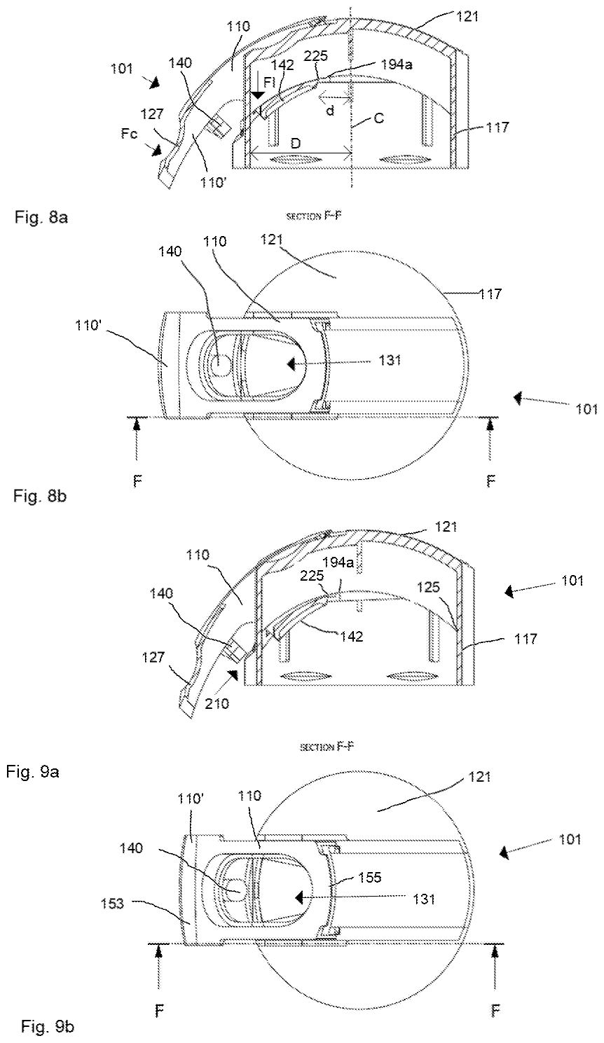

FIGS. 8a,b show views of the cap shown in FIG. 5a,b in the second active position, wherein the actuation portion is not activated;

FIGS. 9a,b show views of the cap shown in FIG. 5a,b in the second active position, wherein the actuation portion is activated.

FIGS. 1 and 2 show views of a pressurized container/aerosol can 2 and a cap 1 of the present disclosure. As can be seen from these figures, the cap 1 is intended to completely cover the top of the container 2, so as to reduce the possibility of tampering with the dispensing unit 5 of the container 2.

The cap 1 is intended to be attached to the container 2. The cap 1 can be manually releasably attached to the container, or manually unreleasably attached thereto. The latter provides an integral design of the cap 1 and the container 2 such that an empty container 2 will be thrown away together with the cap 1 as waste. If the cap 1 is manually releasably attachable to the container 2, the cap 1 can be recycled, i.e. used on more than one container 2, such that an empty container 2 without the cap 1 can be thrown away as waste.

The pressurized container 2 is a cylindrical pressurized tubular container 2 with a dispensing unit 5 comprising a control valve structure which may be fixed near the top of the container 2. The container 2 may have a fluid inlet tube extending down to a zone adjacent the bottom of the container. Other configurations without a fluid inlet tube or a differently configured fluid inlet tube are also possible. The dispensing unit 5 further has a fluid outlet tube 7 extending axially of the container 2 in an air-tight manner through the top of the container, wherein a dispensing push button 9 carrying a spraying nozzle 11 is arranged on the fluid outlet tube 7.

The dispensing push button 9 cooperates with the fluid outlet tube 7 and the container valve. The outlet tube 7 has an operative connection with the control valve structure such that pressure on the dispensing push button 9 and the outlet tube 7 releases pressurized contents from the interior of the container 2 through the valve, the outlet tube 7 and the spraying nozzle 11. The contents could be paint for example. In order to actuate the container 2 to release its contents, it is necessary to provide a downward force onto the dispensing push button 9. This is achieved by providing the cap 1 with an actuation portion 10. This actuation portion 10 is designed to interface with the dispensing unit 5, such that a user of the container can push on the actuation portion 10 and this actuation force is transferred to the dispensing unit 5 to activate the dispensing unit 5 of the pressurized container 2. The actuation portion 10 will be explained in more detail below

The cap 1 shown in FIGS. 3 and 4 is designed to be mounted on an aerosol container 2. The cap 1 comprises substantially: a fixed or stationary body 15 with a peripheral cylindrical side wall 17, at the lower end of which there are formed connectors 19 which engage with the container 2 and hold the cap 1 onto the container 2. The stationary body 15 has a top wall 21 rigidly connected to its side wall 17.

As the cap itself is firmly attached to the container by means of the connectors 19, shaking the container 2 during use is possible without the risk of detachment of the cap 1.

The actuation portion 10 is slidably connected to the stationary body 15, wherein the actuation portion 10 can be slid by a user between a first inactive position shown in FIGS. 3a,d in which the actuation portion 10 forms a part of the top 21 of the cap 1 and a second active position shown in FIGS. 3b,c in which the actuation portion 10 is partly located outside the cap 2. After finishing a process using the container 2 with the cap 1, the actuation portion 10 can be slid by a user back from the second active position to the first inactive position. In the first inactive position the actuation portion 10 is blocked by means of the stationary body 15 to pivot around a pivot axis 25 (FIG. 3d) for activation of the dispensing unit 5 of the container 2. In the second active position, the dispensing unit 5 of the container 2 can be activated by a user by applying a force on the part 10′ of the actuation portion 10 located outside the cap 1 such that the actuation portion 10 is able to pivot around the pivot axis 25.

The top portion 21 of the cap 1 is dome shaped and the actuation portion 10 has a corresponding curved design. As shown in FIG. 4, the top portion 21 of the stationary body 15 has two opposing stepped edges 57, 59 and between the stepped edges 57, 59 the actuation portion 10 is arranged by means of snap fingers 61 at least in the first inactive position of the actuation portion 10 in such a manner that the actuation portion 10 is able to slide over the stepped edges 57, 59. The stepped edges 57, 59 are configured to block a pivoting movement of the actuation portion 10 around the pivot axis 25 for activation. Hence, the stepped edges 57, 59 are provided over only a part of the sliding path between the first and second position of the actuation portion 10. In the region of the second position the top portion 21 has edges without a stepped profile such that the actuation portion 10 is no longer blocked and can be pushed by a user towards the interior of the cap 1 which results in in a pivoting movement around the pivot axis 25 such that the dispensing unit 5 of the container can be activated.

In addition, the side wall 17 of the stationary body 15 comprises a recess 18 providing space for the actuation portion 10 to be slid and to be pivoted around the pivot axis 25 by a user.

The part 10′ of the actuation portion 10 located outside the cap 1 is provided with a gripping section 27 having a number of ribs 29 protruding from the upper surface of the actuation portion 10. The force to be applied on the part 10′ of the actuation portion 10 located outside the cap 1 should be mainly applied transversally with respect to the side wall 17 of the container 2, in particular towards the side wall 17 of the container 2 and this direction for applying the force is indicated by arrow P1 in FIG. 3b. The part 10′ of the actuation portion located outside the cap 1 extends mainly downwards from the cap allowing ease of operation for actuation by a user's finger and also a good grip to the container 2 with the rest of the user's hand.

The cap 1 comprises further a lever 35 pivotably connected to the stationary body 15, such that the lever 35 cannot slide with respect to the stationary body.

In the first inactive position of the actuation portion 10, the lever 35 is located between the dispensing unit 5 and the slidable actuation portion 10.

In the second active position of the actuation portion 10, the lever is connected with a form fit, for example by means of a releasable hook connection, to the actuation portion 10 providing a temporarily rigid connection therebetween such that actuation by a user of the actuation portion 10 pivots the lever 35 and the actuation portion 10 around the pivot axis 25 with respect to the stationary body 15 thereby activating the dispensing unit 5 of the pressurized container 2 to release the contents of the container 2.

The first inactive position can also be identified as the locked position, and the second active position can be identified as the unlocked position. Obviously, the stepped edges 57, 59 are intended to block actuation of the container 2 by stopping the actuation portion 10 in the locked position from being moved relative to the container 2.

The actuation portion 10 is by means of the lever 35 connected to the stationary body 15. The lever 35 is connected to the stationary body 15 by means of a hinge 41. Preferably the hinge 41 is also an integral part of the aerosol cap 1, and is merely a section of material of the cap 1 which connects the stationary body 15 and the actuation portion 10. In particular, the hinge 41 can be a thin strip of the material of the cap 1, i.e. a living hinge, which will then allow rotation and relative motion between the cap 1, the lever 35 and the actuation portion 10.

It is expected that the cap 1 will be fabricated from plastic, as this material can readily be injection moulded and provides a relatively light cap 1. The cap 1 may also be formed of metal, such that a thin joining piece (not shown) makes the hinge allowing relative motion around the pivot axis 25 between the stationary body 15 and the actuation portion 10.

As shown in the FIGS. 3a-d, the first inactive position of the actuation portion 10 provides a cap 1 without a spraying opening for the dispensing unit and the second active position of the actuation portion 10 provides a cap with a spraying opening 31 (FIG. 3c) for the dispensing unit 5. The size of the opening 31 is determined by the distance of the nozzle 11 to the side wall 17 of the stationary body and the spray angle and will result in a width between 15 and 25 mm. The spray angle or spray direction will be approximately perpendicular to the centre axis of the push button 11, i.e. the spray direction is (mainly) in a horizontal direction when the centre axis of the container 2 extends in a vertical direction. However, it is also possible that in a different designed cap (not shown) and a different designed dispensing push button (not shown) the spraying angle is in line with the centre axis of the container 2, i.e. the spray direction is (mainly) in a vertical direction. Further, the spraying direction of the nozzle 11 may also be located between a vertical direction and a horizontal direction such that the spraying angle forms an acute angle with a vertical line and a horizontal line.

As can be seen for example by comparing FIGS. 1a,b, the spraying opening 31 in the cap 1 is provided by sliding the actuation portion 10 from the first inactive position to the second active position of the actuation portion (see also FIG. 3c). The spraying opening 31 is formed or defined by the lever 35 and the actuation portion 110, in particular by an edge 35a of the lever 35 and an edge 10a of the actuation portion 10. A first end of the lever 35 is connected to the stationary body 15 by the living hinge 41 (FIG. 3d) and at least an edge portion of the edge 35a of the lever forming the spraying opening 31 is part of a second end of the lever opposite, seen in a longitudinal direction of the lever 35, to the first end of the lever 35. Further, at least an edge portion of the edge 10a of the actuation portion 10 is in the first inactive position located closer to the first end of the lever 35 connected to the stationary body 15 by the living hinge 41 than to the second end of the lever, wherein in the second active position of the actuation portion 10 this edge portion of the edge 10a of the actuation portion is located closer to the second end of the lever 35 than to the first end of the lever 35.

The edge 10a of the actuation portion 10 can easily be used by a user to slide the actuation portion 10 between the first inactive position and the second active position for unlocking the actuation portion and for providing the spraying opening 31 which is at least partly defined by the edge 10 of the actuation portion 10.

In the first inactive position of the actuation portion 10 (see for example FIG. 3d) a first end of the actuation portion is located closer to the first end of the lever 35 connected to the stationary body 15 by the living hinge 41 than to an opposite second end of the lever 35, wherein in the second active position (see for example FIG. 3c) of the actuation portion 10 the first end of the actuation portion is located closer to the second end of the lever 35 than to the first end of the lever 35. A second end of the actuation portion 10 opposite, seen in a longitudinal direction of the actuation portion, to the first end of the actuation portion 10 is in the second active position located outside the cap 1 as shown in FIG. 3c. The first end of the actuation portion does not protrude from the cap in the first inactive position and in the second active position. In the first inactive position, the second end of the actuation portion 10 is located closer to the first end of the lever 35 than in the second active position. Further, as shown in FIG. 3c, in the second active position, the spraying opening 31 is located between the second end of the actuation portion 10 and the first end of the lever providing the pivotable connection with the stationary body 15.

The actuation portion 10 is slidable over the lever 35, preferably over the complete sliding path between the first inactive position and the first active position. Further, ribs 51 and recesses 53 provided on the actuation portion and the lever define the first inactive position and the second active position of the actuation portion 10.

As shown in FIG. 3c, the part 10′ of the actuation portion 10 located outside the cap 1 is located under the spraying opening 31 in the second active position, such that the spraying opening 31 is located between the virtual center line C (see FIG. 2a) of the cap 1/container 2 and the part 10′ of the actuation portion located outside the cap 1.

A surface 71 of the lever 35 facing the interior of the cap 1 comprises a protruding element 73 abutting the dispensing unit if the cap 1 is provided on the container 2. The protruding element 73 is a cylindrical wall with an opening. This cylindrical wall can be positioned against or around the dispensing push button 9 of the dispensing unit, wherein the opening in the wall is aligned with the spraying nozzle 11.

The low amount of material needed to produce the cap makes it possible to produce a relatively cheap cap.

The cap configuration is also suitable for product/brand differentiation in an efficient manner, because the cap 1 can be a universal cap without the actuation portion 10, whereas the actuation portion 10 can be provided with a product name or an identification, for example a colour if the product in the container is paint. The actuation portion 10 can be snapped into the stationary body 15 to provide the cap 1.

It is also possible that the dispensing unit of the container does not comprise a dispensing push button 9, but comprises the fluid outlet tube 7 as the single exterior feature of the dispensing unit. In such an embodiment the cap (not shown) comprises parts such as a nozzle to dispense the product.

The cap 1 provides an ergonomic grip of the container in use, because the thumb and a portion of the hand of a user extending between the thumb and the index finger can be positioned around at least half of the circumference of the container 2. In this configuration of the hand around the container, the index finger is able to actuate the actuation portion 10′ in such a manner that the content of the container can be released in a direction away from the user having a natural posture in use, i.e. the content is released from the same side as where the part of the actuation portion projects outside the cap. This is achieved by the part 10′ of the actuation portion 10 located outside the cap 1, because the part 10′ is located under the spraying opening 31 in the second active position, such that the spraying opening 31 is located between the virtual center line C (see FIG. 2a) of the cap 1/container 2 and the part 10′ of the actuation portion located outside the cap 1.

FIGS. 5a,b show projected views of a pressurized container 102 with an alternative cap 101. The cap 101 is shown in a second active position in the FIGS. 5a-9b. The cap 101 differs from the cap 1 in that for activating the dispensing push button 109 in the second active position, the actuation portion 110 cooperates with the lever 135 in a different manner.

However, as shown in FIG. 5b, like the cap 1, the part 110′ of the actuation portion 110 located outside the cap 101 is located under the spraying opening 131 in the second active position, such that the spraying opening 131 is located between the virtual center line C (see FIG. 5b) of the cap 101/container 10 2 and the part 110′ of the actuation portion 110 located outside the cap 101. Like the cap 1, the cap 101 has a gripping section 127 located closer to a second end 153 (FIG. 6b) of the actuation portion 110 than to the opening 130 such that the risk during normal use that fluid or product to be dispensed with the dispensing unit 105 through the dispensing opening 131 gets on a finger of a user activating the actuation portion by pushing the gripping section 127 below the spraying opening 131 is prevented.

In order to release the content of the container 102, first the actuation portion 110 is slid, like the actuation portion 10, to the second active position such that the actuation portion is unlocked and ready for use as explained above for the actuation portion 10 and such as shown for cap 101 in for example FIG. 5a. Then, the actuation portion 110 can be activated by an user in a second step which results in activation of the dispensing push button 109 to release the content of the container 102. The activation of the dispensing push button 109 by means of the lever 135 and the actuation portion 110 of the cap 101 is different than the activation of the dispensing push button 9 in the cap 1, in that the actuation portion 110 is able to pivot with respect to the lever 135. In this way a more optimized lever mechanism can be provided, making it easier for a user to activate the dispensing push button 109, i.e. the activation force to be provided by for example a finger of a user on the actuation portion 110 in the second active position can be lowered by this design having a double lever.

FIGS. 6a-9b show the details of the second embodiment of the cap 101 comprising a stationary body 115 having a top portion 121 and a side wall 117.

The actuation portion 110 as for example shown in FIG. 6B comprises two parallel extending side walls 132, 134 which are connected to each other by a top actuation wall portion 136.

The top actuation wall portion 136 comprises an opening 130 for producing the spraying opening 131 in the second active position of the actuation portion 110.

Further, the actuation portion 110 is provided with a sealing element 140. Such a sealing element 140 is advantageous for example if the content of the container 102 is paint. The sealing element 140 seals the nozzle in an airtight manner such that clogging of the nozzle is prevented. The sealing element 140 may be capable of absorbing the paint to avoid clogging of the nozzle. The sealing element 140 may be 2K injection molded (e.g. TPU), or a separately assembled cushion (e.g. neoprene sticker), preferably having a closed cell structure. In the first inactive position of the actuation portion 110, the sealing element 140 may be pressed onto the nozzle 111 to prevent contact between the nozzle with the surrounding atmosphere, wherein by sliding the actuation portion 110 to the second active position the sealing element 140 is moved away from the nozzle 111, as can be seen for example in FIG. 5a, such that for example paint can be released from the container by means of the nozzle 111 through the spraying opening 131 towards an object (not shown).

Each side wall 132, 134 of the actuation portion 110 is provided with a guiding element 142, 144 which laterally projects away from a longitudinal axis of the actuation portion 110. The opening 130 of the actuation portion 110 is defined by an edge 146 which comprises receiving notches 152 (FIG. 6a). The edge 146 is configured such that a user can use a portion of the edge 146 located close to the second end 153 of the actuation portion 110 for sliding the actuation portion 110 from the first inactive position towards the second active position by positioning a finger in the opening 130 on that portion of the edge 146 located closer to the second end 153 than to the first end of the actuation portion and vice versa by positioning the finger in the opening 130 on a portion of the edge located closer to the first end 153 than to the first end 155 of the actuation portion 110 such that the user is able for sliding the actuation portion 110 from the second active position towards the first inactive position.

The lever 135 comprises a front section 162, a top section 164 and two side sections 166, 168 which are connected to each other by the front section 162 and the top section 164. The front section 162 and the top section 164 of the lever 135 define an opening 160 which in the second active position of the of the actuation portion 110 coincides, at least partly, with the opening 130 of the actuation portion 110 for providing the spraying opening 131. Hence, in the cap 101 the spraying opening is formed by the lever 135 and the actuation portion 110, in particular by the opening 160 of the lever 135 coinciding with the opening 130 of the actuation portion 110.

Like in the cap 1, the lever 135 of the cap 101 is pivotally connected to the stationary body 115 of the cap 101, preferably by a living hinge as described above for cap 1. The lever 135 further comprises two projecting elements 176, 178 which cooperate with the receiving notches 152 of the actuation portion 110 for providing a stop and/or an indication to the user sliding the actuation portion 110 from the first inactive position towards the second active position that the second active position has been reached.

The projecting elements 176, 178 and the receiving notches 152 may be designed as child safety elements to provide a child proof cap 101, i.e. the projecting elements 176, 178 and the receiving notches 152 may provide a threshold for using the cap, wherein the threshold may for example be a resistance that needs to be overcome such as shown in the design of the cap 101 and/or may require an additional operation (not shown) of a user than sliding the actuation portion 110 towards the second active position for operating the dispensing unit 105.

The edge 146 defines a relatively large surface for a user's finger which increases the ease of use of the cap to overcome the resistance provided by the child safety features.

The lever 135 is further provided with frangible bridges 172, 174 which are arranged opposite to the first end which is pivotally connected to the stationary body 115. By means of the frangible bridges 172, 174 the lever 135 is also connected to the stationary body 115. However, upon applying a force by a user on the actuation portion 110′ in the second active and unlocked position for the first time, these frangible elements 172, 174 break such that the lever 135 is able to be moved by means of the actuation portion 110, i.e. the lever 135 is able to pivot around pivot axis 125 for operating the dispensing unit 105.

In the assembled state of the cap 101 as shown for example in FIGS. 7a,b inner sides 134a (FIGS. 6a, 6b) of the sidewall 132, 134 abut against or are located close to outer sides of a side wall 166, 168 of the lever 135 in such a way that the inner sides 132a, 134a of the sidewalls 132, 134 are able to move with respect to the outer sides of the side wall 166, 168 of the lever 135. Each guiding element 142, 144 of the actuation portion 110 comprise a guiding surface 144a (FIG. 6a, but not shown in the figures for guiding element 142) abutting in a sliding manner against a bottom edge 194a, 196a of an inner wall 194, 196 of the stationary body 115.

Contrary to the cap 1, the actuation portion 110 of the cap 101 does not lock onto the cap lever 135, for forming a temporary connection for extending the lever 35 with the actuation portion 10 as described above for the cap 1. Instead, the actuation portion 110 provides in the second active position a separate lever that actuates the cap lever 135. The cap 101 therefore comprises two levers, pivoting about two different axes. The first pivot axis 125 is identical to the pivot axis 25 of the cap 1 and operates in the same manner as has been described with reference to the above description of the cap 1. The second pivot axis 225 is provided by end portions of the guiding surfaces 144a, i.e. the end portions of the guiding surfaces 144a facing the first pivot axis 125, wherein these end portions of the guiding surfaces 144a are supported in a pivotable fashion on the inner walls 194, 196 of the stationary body 115. In the second active position, the two projecting elements 176, 178 (FIG. 6a) are positioned in the receiving notches 152 of the actuation portion 110, in such a manner that by activating the actuation portion 110′ by a force Fc (FIG. 8a), the receiving notches 152 of the actuation portion 110 transfer a force FI extending parallel to the center line C to the two projecting elements 176, 178 of the lever 135. This force FI causes the lever 135 to move downwards, but also causes the actuation portion 110 to rotate around second pivot axis 225. By means of the receiving notches 152 cooperating with the two projecting elements 176, 178 of the lever 135, the actuation portion 110 will pivot around the second pivot axis 225 and the risk of undesired movements, for example sliding, of the actuation portion 110 with respect to the lever 135 are minimized/prevented, because the two projecting elements 176, 178 of the lever 135 are located in the receiving notches 152 of the actuation portion 110. As can be seen by comparing FIGS. 8a and 9a by applying the force Fc the distance indicated by arrow 210 between the sealing element 140 and the side wall 117 of the stationary body is reduced. The rotation of the actuation portion 110 around the second pivot axis 225 provides a mechanical leverage advantage in that the force to be exerted by a user for activating the dispensing unit 105 and/or for holding the dispensing unit 105 in an activated position can be further reduced. This is in particularly advantageous for processes in which the time periods for holding the dispensing unit 105 in an activated position, such as for example in a painting process, are relatively long. Hence, this double lever configuration in the cap 101 further contributes in reducing the force to be exerted by a user for activating the dispensing unit 105 which further reduces the risk of finger fatigue or fingertip numbness. This together with the ergonomic design of the cap 101, provides a cap 101 which is user-friendly in use.

In the cap 101 the location of the pivot axis 225 to be formed during use of the cap 101 is located between the center line C of the cap 101 and the recess/opening 118 provided in the side wall 117 for sliding the actuation portion 110 out of the cap 101. The mechanical leverage advantage can be increased by increasing distance d (FIG. 8a) between the center axis C and the pivot axis 225, wherein the distance d is measured transversely to a direction of the center axis C, starting from the center axis C. The distance d is 5-50% of the distance D corresponding to distance between the the recess/opening 118 and the center axis C. Preferably the distance d is between 20-35%.

The cap 101 further comprises an alignment element 170. The alignment element 170 is provided with a recess 171. When assembling the cap 101 and the container 102 the recess 171 is connected with a cam/projecting element (not shown) fixed to the dispensing unit 105, wherein this connection assures that the nozzle 111 of the dispensing unit 105 is aligned with the position of the spraying opening 131 of the cap 101 before using the cap 101. Further, it is guaranteed by the connection between the recess 171 and the cam/projecting element that the nozzle 111 remains aligned with the spraying opening 131, i.e. by means of the connection the nozzle 111 will rotate in the same direction together with the cap 110 when the cap is rotated for example around the virtual center line C (FIG. 5b), such that the connection guarantees that the spraying opening 131 remains aligned with the nozzle 111.

1. Cap for a pressurized container with a dispensing unit, wherein the cap comprises a stationary body configured to be attached to the container such that the stationary body encloses the dispensing unit of the container, the cap further comprises an actuation portion for activation of the dispensing unit of the pressurized container, the actuation portion is slidably connected to the stationary body, wherein the actuation portion can be slid by a user between a first inactive position in which the actuation portion forms a part of the top of the cap and a second active position in which the actuation portion is partly located outside the cap and vice versa, wherein in the first inactive position the actuation portion is blocked by means of the stationary body to pivot around a pivot axis for activation of the dispensing unit and in the second active position the dispensing unit can be activated by a user by applying a force on the part of the actuation portion located outside the cap such that the actuation portion pivots around the pivot axis.

2. Cap according to claim 1, wherein the first inactive position of the actuation portion provides a cap without a spraying opening for the dispensing unit and the second active position of the actuation portion provides a cap with a spraying opening for the dispensing unit.

3. Cap according to claim 1, wherein the cap comprises a lever pivotably connected to the stationary body, wherein in the first inactive position the lever is located between the dispensing unit and the slidable actuation portion.

4. Cap according to claim 3, wherein in the second active position of the actuation portion, the lever is connected to the actuation portion such that actuation by a user of the actuation portion pivots the lever and the actuation portion around the pivot axis with respect to the stationary body thereby activating the dispensing unit of the pressurized container.

5. Cap according to claim 3, wherein a first end of the lever provides the pivotable connection with the stationary body, wherein in the first inactive position of the actuation portion a first end of the actuation portion is located closer to the first end of the lever than to an opposite second end of the lever, wherein in the second active position of the actuation portion the first end of the actuation portion is located closer to the second end of the lever than to the first end of the lever.

6. Cap according to claim 3, wherein the actuation portion is slidable over the lever, wherein ribs and at least one recess provided on the actuation portion and the lever define the first inactive position and the second active position of the actuation portion.

7. Cap according to claim 3, wherein the stationary body comprises a top portion defining the top of the cap, wherein the top portion has two stepped edges and between the stepped edges the actuation portion is arranged at least in the first inactive position in such a manner that the actuation portion is able to slide over the stepped edges.

8. Cap according to claim 7, wherein the stepped edges are configured to block a pivoting movement of the actuation portion around a pivot axis for activation.

9. Cap according to claim 7, wherein the stepped edges are provided over a part of the sliding path of the actuation portion for sliding between the first and second position.

10. Cap according to claim 3, wherein a surface of the lever facing the interior of the cap comprises a protruding element abutting the dispensing unit.

11. Cap according to claim 1, wherein in the first inactive position the actuation portion provides a cap covering the top of the container such that a finger of a user cannot access the dispensing unit of the container.

12. Cap according to claim 3, wherein the lever is pivotably connected to the stationary body by means of a living hinge.

13. Cap according to claim 1, wherein the cap without the actuation portion is a non-tailor-made cap, and the actuation portion is tailor-made and includes a product name or other identification.

14. Cap according to claim 1, wherein the actuation portion is snapped into the stationary body to provide the cap.

15. Container comprising a dispensing unit and a cap according to claim 1.

16. Container according to claim 15, wherein the cap is manually releasably attached to the container.

17. Container according to claim 15, wherein the cap is manually unreleasably attached to the container.
